(19) United States
(12) Patent Application Publication
(10) Pub. No.: US 2026/0298880 A1
(43) Pub. Date: Oct. 1, 2026

(54) SYSTEM AND METHOD FOR ACOUSTIC SPECTROSCOPY FOR FLUID MEASUREMENT

(71) Applicants: Petróleo Brasileiro S.A. - Petrobras, Rio de Janeiro (BR); Universidade Federal do Rio de Janeiro - UFRJ, Rio de Janeiro (BR)

(72) Inventors: Marco Antonio Gomes TEIXEIRA, Niteroi (BR); Marcelo Ferreira de Souza ALVES, Rio de Janeiro (BR); Ricardo Tokio HIGUTI, Ilha Solteira (BR); Guilherme Henrique da Silva CAIRO, Rio de Janeiro (BR); Mateus de Souza Brasil da SILVA, Rio de Janeiro (BR); Júlio Cesar Eduardo de SOUZA, Ilha Solveira (BR); Marcelo Moreira TIAGO, Ouro Preto (BR); Rafaella Magliano Balbi de FARIA, Rio de Janeiro (BR); Aline Machado de Azevedo NOVAES, Rio de Janeiro (BR); Rogerio Mesquita de CARVALHO, Rio de Janeiro (BR); Ana MEHL, Rio de Janeiro (BR); Thiago Gabrig CORREIA, Rio de Janeiro (BR); Rossana Mara da Silva Moreira THIRÉ, Rio de Janeiro (BR)

(73) Assignees: Petróleo Brasileiro S.A. - Petrobras, Rio de Janeiro, RJ (BR); Universidade Federal do Rio de Janeiro - UFRJ, Rio de Janeiro, RJ (BR)

(21) Appl. No.: 19/577,189

(22) Filed: Mar. 24, 2026

(30) Foreign Application Priority Data
Mar. 31, 2025 (BR) 1020250063670

(51) Int. Cl. G01N 29/22; G01N 29/024; G01N 29/032

(52) U.S. Cl. CPC G01N 29/222; G01N 29/024; G01N 29/032; G01N 29/223; G01N 2291/011; G01N 2291/015; G01N 2291/0226; G01N 2291/048

(57) ABSTRACT

Described herein are systems and methods for performing acoustic spectroscopy using pulsed transmission-reception or pulse-echo techniques. A system includes a central hole for direct insertion of a liquid of interest to be analyzed, or a cuvette with a liquid for acoustic coupling. Two additional holes are arranged on the sides of the central hole. An acoustic transducer can fit into each side hole. A sealing ring ensures the system is sealed. The system includes support arms to support the weight of the transducers. The end of each arm includes an elliptical-shaped structure with three holes configured to receive nuts and bolts that are used to move the transducers to ensure the transducers obtain quality signals and maintain the position of the transducers in a desired position to facilitate repeatability in successive experiments.

### CROSS-REFERENCE TO RELATED APPLICATIONS

This application claims priority of Brazilian application Ser. No. 1020250063670, filed Mar. 31, 2025, the entire contents of which is incorporated herein by reference.

### FIELD

The present invention pertains to the technical field of oil and gas, and is related to the investigation and analysis of various fluids by using ultrasonic waves, more specifically, related to technologies for measuring mechanical vibrations or ultrasonic waves using a detector in a fluid, and refers to an acoustic spectroscopy system and method manufactured by 3D printing, which can be used for measuring various fluids.

### BACKGROUND

The acoustic spectroscopy is a fast and safe analytical technique for the characterization of liquids and dispersions (BONACUCINA et al., 2016) that is based on tracking ultrasound waves traveling through a sample of interest (CARVALHO, 2013). Thus, the success of the applications is typically related to the quality of the acoustic signals captured, which is usually addressed in the literature with the development of experimental apparatus designed and optimized for specific applications. Fixing ultrasound transducers to ensure better repeatability in analyses is also highlighted as a common practice.

Adamowski et al. (1995) show the importance of planning the dimensions of the acoustic measurement cell to achieve isolated signals with a high signal-to-noise ratio, both important in the data processing step. Tiago et al. (2019) combine planning with the use of commercial cuvettes for sample storage, which makes the measurement system more versatile and easier to clean, speeding up successive analyses.

Furthermore, Tiago et al. (2019) innovate in the application of cuvettes combined with a support to hold them together with the transducers, which can be kept fixed between successive experiments. Both the system of Adamowski et al. (1995) and that of Tiago et al. (2019) are centered on metallic structures which, although robust, require specialized labor for precision machining, have high costs and laborious manufacturing.

In view of the disclosure above, in order to solve the limitations and technical problems previously described, there were developed an acoustic spectroscopy support or system manufactured by 3D printing under pulsed transmission-reception or pulse-echo technique, thereby reducing its cost and facilitating manufacturing, and an acoustic spectroscopy method for measuring various fluids.

The system can be used to measure multiphase systems (oil-in-water and water-in-oil emulsions in the presence of solids) considering the obtaining of properties associated with the sound propagation and the association of these data with other variables (for example, stability of multiphase systems, action of chemical products, concentration of dispersed phases).

### STATE OF THE ART

The scientific paper by Alves et. al (2022), titled “Caracterização ultrassônica de fluidos em cubetas: investigação de metodologia” (“Ultrasonic characterization of fluids in cuvettes: methodology investigation”) is part of the state of the art and describes a methodology with an experimental setup and a cell produced by 3D printing using PLA, investigated with experiments in distilled water. The proposal involves calculating properties based on two acoustic signals measured in the same experiment: the pulse that propagates directly between the emitter and the receiver and its reverberation inside the cuvette. The difficulty in the method is the possible superposition of spurious signals on the second echo signal of interest.

It can be noted that, although this document shows the positioning of the transducers with a metal plate, it does not introduce the use of fixation with printed parts or even with a printing arrangement that takes advantage of a commercially available polymeric connector. The advantage over metal preparation is evident, because if positioning with rigid parts (such as metals) is a paradigm for obtaining invariant positioning of the transducers in the final apparatus, always guaranteeing the same longitudinal propagation, it also brings great difficulty in overcoming machining inaccuracies, which inevitably occur.

In other words, it is indeed possible to always obtain the same longitudinal propagation with metal fixation devices, but not necessarily in optimal conditions. The possibility of fine adjustment brought by the present invention with malleable parts overcomes this difficulty of the fixed metal systems which, as mentioned earlier, for delicate measurements such as those proposed, were a paradigm.

In turn, the scientific paper by Tiago et. al (2019), titled “Versatile ultrasonic spectrometer for liquids with practical sample handling by using standard cuvettes”, describes the development and testing of an ultrasonic spectrometer for liquids based on the use of commercial cuvettes for sample handling. Backscatter studies of 10 and 15 μm diameter polystyrene particles were carried out, showing the versatility of the instrument.

Although some similarities are realized, this document does not comment on the possibility of varying the acoustic path of the cuvette, that is, of altering the longitudinal propagation as a way to obtain more information from the system being measured, and also on the possibility that the invention brings to, for certain fluids, perform the measurement without cuvettes to affirm that the propagations are aligned by obtaining a good signal-to-noise ratio, or to calculate the correct distance between the transducers by the direct propagation in a reference medium.

Document U.S. Pat. No. 6,672,166B2 describes a system consisting of an ultrasonic transducer and a filter supporting the transducer. To suppress the transmission of ultrasonic signals through a housing of the ultrasonic transducer array, the filter is provided with a vibrating plate to emit ultrasonic waves, and is coupled to a deflector segment that converts radial movements of a first section of the filter into torsional movements of a second section of the filter.

Finally, document WO2018236274A1 is also part of the general state of the art and protects a holding arrangement for an acoustic transmitter in an acoustic spectroscopy system. The arrangement comprises: a body comprising a cavity for holding an acoustic transmitter, the cavity comprising an opening arranged to face the container, when the arrangement is fixed to a container.

It can be noted that this document does not mention the use of processing resources for attribution. In the case of the present invention, it is considered that there is a time of a few microseconds without temperature oscillation and that during this time a stationary state is considered and therefore suitable to be considered homeothermic. Experimental measures, such as the search for the best positioning of the sensor, accompany the concern with the mathematical processing. This search is related to the monitoring of the processed data, which allows the positioning of the sensor to be optimized with the assembly and way of processing of the invention.

It can be noted that this document does not explicitly mention, for example, any type of support for something like a sample holder (function of the cuvette in the present invention) or a system that, like that of the present invention, can be adapted for time of flight or pulse-echo.

In view of the disclosure above, it is further important to highlight that the present invention offers advantages over the state of the art, since it does not require the use of solvents for measurement and presents less exposure to risk. In addition, it allows the measurement of oil-in-water emulsions without the need for extraction. There is further a noticeable improvement in speed, reproducibility, and confidence in the result.

### SUMMARY

The present invention relates to a system and method for operating acoustic spectroscopy under pulsed transmission-reception or pulse-echo technique. There is a central hole for direct insertion of the liquid of interest to be analyzed or a cuvette and a liquid for acoustic coupling. On the sides of the central hole, there are two additional holes for fitting an acoustic transducer in each side hole. The use of a sealing ring (commercially available or also 3D printed) ensures the sealing of the system. The structure also has support arms to support the weight of the transducers. Additionally, at the end of each arm, there is an elliptical-shaped structure with three holes that allows the insertion of nuts and bolts used to move the transducers, allowing their fundamental alignment to obtain quality signals. Once they are aligned, the structure allows the maintenance of the positioning, contributing to the repeatability in successive experiments.

### BRIEF DESCRIPTION OF THE FIGURES

The patent or application file contains at least one drawing executed in color. Copies of this patent or patent application publication with color drawing(s) will be provided by the Office upon request and payment of the necessary fee.

To obtain a complete and thorough visualization of the object of this invention, the following figures are presented and referenced.

FIG. 1 schematically represents examples of supports developed with 3D printing for acoustic spectroscopy; wherein A: basic support or cell for operation with (or without) a cuvette with 30 mm nominal path length; B: support or cell for operation with (or without) a cuvette with 30 mm nominal path length that allows liquid circulation around the sample for temperature control.

FIG. 2 schematically shows drawings of the acoustic measurement system and representation of the acoustic path of the main pulses in data processing; wherein A: operation without cuvette; B: operation with cuvette.

FIG. 3 schematically represents acoustic signals obtained for distilled water with 20 MHz transducers in cuvettes of: 1-10 mm and 2-20 mm; wherein A: complete acoustic spectrum captured; B: highlight for pulse detection a1; C: highlight for pulse detection a2.

FIG. 4 schematically represents acoustic signals obtained for distilled water in a 30 mm cuvette with 20 MHz transducers; wherein A: complete acoustic spectrum captured; B: highlight for pulse detection a1; C: highlight for pulse detection a2.

FIG. 5 schematically represents the acoustic spectrum obtained when evaluating water in a polystyrene cuvette.

FIG. 6 schematically represents the acoustic spectrum obtained when analyzing distilled water in the system known in the state of the art (Tiago et al. (2019)), but without the use of a cuvette. The effective sample distance is 13.554 mm; wherein A: complete acoustic spectrum captured; B: highlight for pulse detection a1; C: highlight for pulse detection a2.

FIG. 7 schematically represents a graph of the experimental measurements of propagation speed in water as a function of the temperature under natural fluctuations.

FIG. 8 schematically represents graphs that demonstrate the temporal evolution of time of flight and temperature in the acquired time series; wherein A: M1; B: M2; C: M3.

FIG. 9 schematically represents graphs of the influence of the temperature sensor position; wherein A: investigated temperature sensor tip positions; B: sound speeds as a function of temperature.

FIG. 10 schematically represents a flowchart for calculating experimental temperature and speed resolutions.

FIG. 11 shows the steps that were followed to perform data processing for the example of embodiment an analysis of reference saline waters.

FIG. 12 represents a graph of the size distribution of droplets dispersed in oily waters with 0 to 1000 ppm of oil.

FIG. 13 represents a graph of the attenuation coefficient measured at 40 MHz for synthetic oily waters in an initial analysis.

FIG. 14 represents flowcharts of the data acquisition methodology considered in the first two batches in emulsions.

FIG. 15 represents a graph of the acoustic path length as a function of temperature for DGA2 calibration.

FIG. 16 represents the graph of the autocorrelation spectrum of the acquired temperature in an experiment used as an example in the present invention.

### DETAILED DESCRIPTION

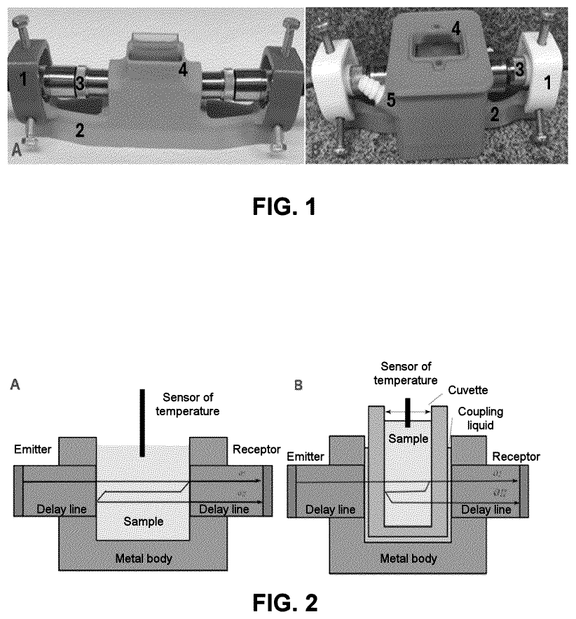

The present invention relates to a system for operating acoustic spectroscopy using pulsed transmission-reception or pulse-echo techniques. The system is shown in FIG. 1, which presents examples of the developed support. It is a 3D printed structure designed for operating acoustic spectroscopy using pulsed transmission-reception or pulse-echo techniques.

There is a central hole (4) for direct insertion of the liquid (fluid) of interest to be analyzed or a cuvette and a liquid for acoustic coupling. On the sides of the central hole (4), there are two secondary side holes for fitting and aligning acoustic transducers (3) in each secondary side hole (3). The use of a sealing ring (5) (commercially available or also 3D printed) ensures the sealing of the system.

The structure also has support arms (2) to support the weight of the transducers. Additionally, at the end of each support arm (2), there is an elliptical-shaped structure with 3 holes (1) that allows the insertion of nuts and bolts used to move the acoustic transducers (3), allowing their fundamental alignment to obtain quality signals. Once they are aligned, the structure allows the maintenance of the positioning, contributing to the repeatability in successive experiments.

For the manufacturing of the system, the 3D printed elements (typically, the cell body and structures to assist in aligning the transducers) can be manufactured with commercially available polymer filaments, such as PLA, ABS, PETG, or not. In the case of eventual printing of sealing rings, typically, the final product has desired flexibility, which should be reflected in the choice of materials. For the other printed materials, rigidity is typically the objective. It is noteworthy that the nuts and bolts used in the assembly can also be obtained via 3D printing, or commercial products can be used, typically made of metal alloys.

Dedicated versions of the system or support have been developed to accommodate commercial cuvettes with a nominal path length of 10 mm, 20 mm, or 30 mm. Among the versions for different path lengths, the size of the central hole (4) is varied, preferably varying by 1 mm, and dedicated solutions are chosen for operation with cuvettes of a specific size due to better accommodation, in which the movement of the cuvette is limited, ensuring better alignment and repeatability. Different versions of the system or support also allow an operation without the actuation of a temperature control mechanism directly in the system or with coupling of lines for fluid circulation around the sample behavior.

The actuation of some mechanism for temperature control, directly or not in the system, is important given the influence of the temperature on the measured acoustic properties. Finally, the possibility of altering the dimensions of the secondary side holes, preferably varying by 1 mm, to support transducers of different dimensions is highlighted. FIG. 1 presents examples without (FIG. 1-A) and with (FIG. 1-B) the possibility of actuation for temperature control directly in the system manufactured for cuvettes with 30 mm path length and operation with V354-SU transducers (Olympus).

Regarding the technical work taken as a basis for the better development of the system, the investigation of cuvettes with alternative path lengths stands out. In the state of the art, it is possible to find solutions only in 10 mm cuvettes, while the present invention investigates path lengths of 10, 20 and 30 mm. Greater distances traveled by the ultrasound in the sample allow for greater interaction, resulting in more distinct received acoustic pulses in relation to the input pulses in the system, which improves the resolution of analyses.

In addition, altering the distance mitigates spurious overlaps in the pulses of interest. Conversely, the waves are more attenuated (a phenomenon proportional to the distance traveled), which negatively impacts the signal-to-noise ratio (SNR) in the received pulse.

The diffraction effect of the beams is also intensified, which can impair the analyses. In this sense, investigating different distances traveled in a sample of interest is an alternative to find the ideal separation between transducers in the experiments for the best resolution.

FIG. 2 also presents schematic drawings of the developed acoustic measurement systems, highlighting the main elements and the two main signals of interest to acoustic processing: pulse a1, which is the first to travel through all the elements between the ultrasound emitter and receiver elements, and pulse a2, corresponding to a reverberation of a1 inside the sample. FIG. 2-A presents a scheme for operating the system without a cuvette. FIG. 2-B shows a scenario analogous to that presented in the state of the art, with a cuvette.

In both schemes, representations considering transducers with a delay line stand out, typical in high-frequency transducers, which, while allowing the emission of signals with better quality, add interfaces in the acoustic path, responsible for increasing the number of detected acoustic pulses given the possible reverberations in the line.

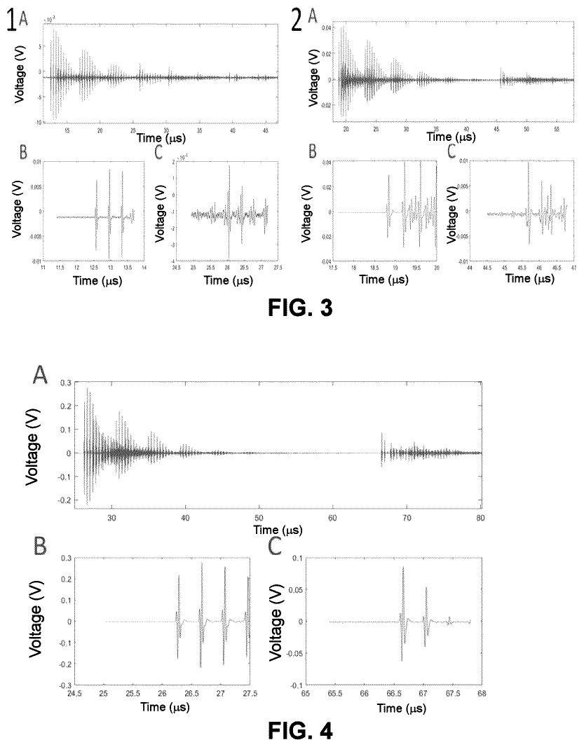

In FIG. 3-A, typical signals obtained in transmission-reception operation with an optical glass cuvette with a nominal path length of 10 mm are presented. In FIG. 3-A-1, the “complete” acoustic spectrum is presented from before the detection of a1 to after the detection of a2. In FIG. 3-A-2, the detection region of the pulse a1, detected between approximately 12.4 and 12.8, is highlighted. In FIG. 3-A-3, the detection region of the pulse a2, detected between approximately 25.7 and 26.3, is highlighted. FIGS. 3-B and 4 are analogous to FIG. 3-A, but refer to the operation with optical glass cuvettes with a path length of 20 mm and 30 mm respectively.

In relation to the acoustic model, in the acoustic spectra obtained when using a cuvette, groups of signals in a shape similar to triangles are noted that repeat, although with decreasing amplitude, approximately every 4.35 μs. Considering the construction information of the transducers provided by the manufacturer, these sets originate from reverberations in the delay line; more specifically, the first signal of each of these sets.

The other pulses in each “triangle” set correspond to reverberations in the walls of the cuvette (higher amplitude signals) and in the acoustic coupling layers (lower amplitude signals). As the attenuation is a phenomenon proportional to the distance traveled by the pulses, the captured signals generally have decreasing amplitudes as a function of the detection time. The pulse a2 stands out in the spectrum as an exception, being the first signal detected with a magnitude greater than expected considering the decay pattern of the pulses in the referenced “triangle” sets.

In FIGS. 3-1-B, 3-2-B and 4-B, there are noted isolated detected signals al and with an intact shape, similar to what is expected according to the characterization of the manufacturer of the used transducers. Considering the acoustic model, this is made possible by the sufficiently large size of the cuvette walls (about 1.25 mm) and the thickness of the coupling layer, designed at about 0.5 mm for the developed supports.

However, the pulses a2 are not always detected in isolation, judging by their shape in the time domain of signals detected (or not) nearby. In light of the acoustic model, the overlaps that affect the signal a2 for small acoustic path lengths in the cuvette originate from some joint pulse generated by pulses that reverberate in the delay line.

By increasing the acoustic path length, the greater distance traveled by the pulse a2 gives enough time for the reverberations in the delay line, after the acoustic emission, as well as signals originating from the same, to have an insignificant amplitude compared to the signal a2. In particular, from FIGS. 3-1-C, 3-2-C and 4-C, only for the nominal path length of 30 mm when using a cuvette is the pulse a2 detected in isolation, this being the suggested size.

The tests for investigating acoustic path length when applying cuvettes were performed with distilled water as a sample, a substance with a low acoustic attenuation coefficient and an ultrasound propagation speed close to 1500 m/s under ambient conditions. For samples with similar characteristics, the conclusions about the ideal acoustic path length tend to be similar as well. For samples in which ultrasound propagates more slowly, the pulses a2 tend to be detected over longer times, and thus, smaller path lengths may be sufficient for isolation of a2.

In the case of higher speeds, it is necessary to reassess the suitability of the 30 mm path length. For samples more attenuating than water, such as oils, in addition to isolation of a2, it is necessary to assess whether the amplitude of the signals a2 is large enough for the desired analyses. A solution for highly attenuating samples (or when cleaner spectra are desired) is to abandon the use of cuvettes, which provides acoustic spectra with fewer pulses, mitigating the possibility of spurious overlaps.

It is noteworthy that another possibility for spectra with fewer pulses, although with more spurious pulses than the cuvette-free scenario, is to change the selection of the cuvette material to materials with acoustic impedance closer to that of the liquid under investigation, such as plastics, preferably polystyrene and acrylic. The proximity of impedances favors the acoustic transmission over the reflection, mitigating the number of significant reverberations on the cuvette wall.

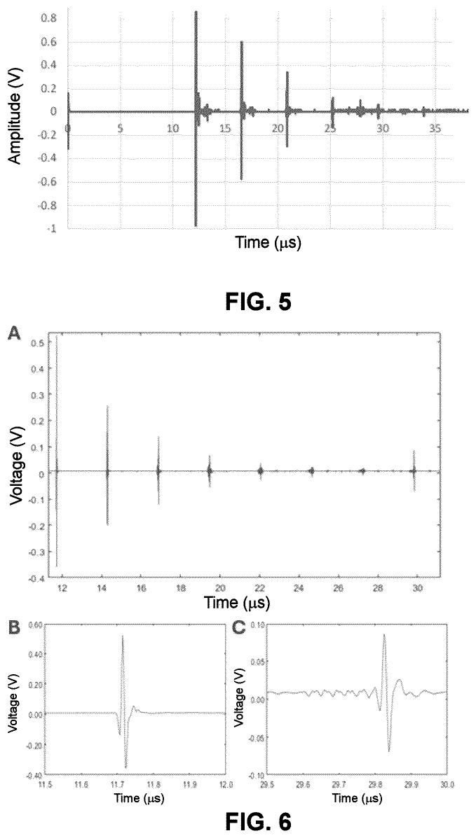

This is shown in FIG. 5, a measurement of water in a polystyrene cuvette. However, compared to the cuvette-free scenario, in addition to the problems with the repetitive alignment to ensure the experimental repeatability, the construction of plastic cuvettes is less precise than cuvettes made of denser solids, such as glass and quartz, impairing the experimental repeatability.

Another problem is that the similarity of impedances also decreases the amplitude of the signals a2, which may eventually not even be detected. In this scenario, only relative data processing would be possible, considering pulses a1 from different experiments.

FIG. 6 shows an example of a typical spectrum when abandoning the use of a cuvette, which was obtained in the state of the art. It is noteworthy an additional benefit of abandoning the cuvette is the greater amplitude of the received signals compared to the scenario with a cuvette, which is explained by the lower number of energy losses in the transmission through interfaces.

From FIG. 5, an isolated pulse a1 is noted, but spurious overlaps are still detected in a2, whose detection coincides with the reverberations in the delay line of the transducers. Compared to FIG. 3-1, however, the overlap in a2 is less intense, with pulses a1 and a2 having similar shapes. A possible solution to further mitigate the overlap, while maintaining a smaller distance, is to modify the temperature of the analyses, which results in the displacement of a2.

It is important, however, to always specify the temperature at which the analyses are conducted given its influence on the acoustic properties. In this sense, the importance of temperature constancy linked to acoustic measurements that one wishes to compare is also highlighted, because otherwise, this is an additional source of variability.

The temperature control is not a trivial task, especially when a high-resolution performance is desired. Thus, the temperature constancy may not be feasible. In this sense, applying corrections to the measured acoustic properties may be a solution.

Table 1 presents analyses of triplicates performed in distilled water in the measurement systems based on cuvettes with 10 mm, 20 mm, and 30 mm path lengths. There are calculated the average and standard deviation of the measured temperatures and of the measured propagation speeds by applying direct cross-correlation between pulses a1 and a2, followed by Hilbert transform interpolation, and of the propagation speeds corrected for a temperature of 25° C.

The correction applied consists of adding to the measured speed the difference between the speed predicted for the measurement temperature and the speed predicted for the reference temperature, that is, 25° C. The prediction is made by using a reference equation for the sound speed in water as a function of the temperature available in the literature.

The prediction is made by using a reference equation in the literature for the speed of the ultrasound in the sample. For water, some references can be cited, such as Del Grosso and Mader (1972), Wilson (1959), Bilaniuk and Wong (1993, 1996) and Lubbers and Graaff (1998). The different equations are distinguished by the temperature range in which they are applicable, the complexity of their format (degree of the polynomial), the expected error when using the same, among other elements.

For the case study, the equation presented in Bilaniuk and Wong (1993, 1996) was selected, whose predictions are in accordance with the currently used international temperature scale (ITS-90) and has a very low reported uncertainty, on the order of 14 ppm.

$$c = 1.40238744 * E + 3 + 5.03836171 * T - 5.81172916 E - 2 * {T}^{⋀} 2 + 3.34638117 E - 4 * {T}^{⋀} 3 - 1.48259672 E - 6 * {T}^{⋀} 4 + 3.1658502 E - 9 * {T}^{⋀} 5.$$

where c is the speed of sound in water as a function of temperature.

TABLE 1
Analysis of triplicates in water with and without application
of a correction to the ultrasound propagation speed based
on a reference equation for the temperature effect

| | Speed (m/s) | | Speed at 25° C. (m/s) | | Temperature (° C.) | |
|---|---|---|---|---|---|---|
| | Average | SD | Average | SD | Average | SD |
| 10 mm | 1483.106 | 1.232 | 1488.679 | 0.834 | 22.979 | 0.724 |
| 20 mm | 1490.639 | 0.717 | 1494.100 | 0.192 | 23.729 | 0.191 |
| 30 mm | 1488.618 | 2.027 | 1489.910 | 1.099 | 24.521 | 0.344 |

The systematic reduction of the standard deviation of triplicates in water, when considering corrections in ultrasound speed, confirms its relevance. Its applicability, however, is not possible, as proposed, for any sample. In the case of water, the usual reference in the state of the art, the behavior of the speed as a function of the temperature is widely studied and reported in the state of the art. For other samples, pure or mixtures, of defined or undefined composition, a prior knowledge may not be available.

Thus, it is imperative to propose alternatives for correcting the temperature effect. In this sense, one option is to perform multiple experiments at different temperatures obtained actively (with control) or passively (natural fluctuation, without control). From the experiments, a data-based approach is adopted to quantify the behavior of the acoustic property of interest as a function of the temperature, obtaining a correlation.

The main benefits of the strategy are agility, capturing the evolution of the variables over time, as well as the opportunity for post-processing in the series to mitigate the experimental variability of each acquisition, such as through moving averages. The time series also allow for a greater understanding of the role of the noise in the measurements.

However, the strategy is not trivial and requires studies of the best approach for data acquisition and processing. It is necessary to acquire data sequentially over time (time series) for a sufficiently long total time, so that the same state of the system is evaluated multiple times throughout the monitoring, that is, in the end, there are replicate evaluations (redundancy) even when performing a single experiment.

As the experiment is conducted in a steady state, with a fixed control target on the controlled variables, the variations in the measured properties are expected to be low; considering that there are always measurement errors in real data, the singular evaluation of experimental conditions may mask the expected low real variations and prevent accurate future developments.

By adopting the proposed approach of time series acquisitions, the information redundancy allows for the evaluation of the distribution of the measurement errors and, once known, can be remedied with the post-processing discussed. The mere existence of the time series also allows for the observation of distinctions in the data with finer ranges compared to the imposed control limits, if the measurements are performed with instruments with resolution higher than the control limits.

Thus, the necessary steps in the proposed methodology are:
1—constructing an experimental acoustic spectroscopy apparatus with instrumentation (and data processing scheme, when applicable), such as the system of the present invention, that allows for measurement resolution of the variables of interest higher than the limits of the imposed active control;
2—executing an active control of variables of interest and wait until a steady state is reached;
3—monitoring variables of interest for a sufficiently long time to allow for multiple evaluations of the same state of the dependent variable in the range of interest.

For statistical reasons regarding the representativeness of an effect by a set of replicates, it is recommended that at least 5 evaluations of each state be available (SCHWAAB and PINTO, 2007). The minimum total monitoring time will depend on each particular system operated, in particular, on how fast the dynamics of the controlled variables is and the time required for the acquisitions.

4—analyzing all measurements in the time series jointly, in order to characterize and mitigate the impacts of the individual noise from each measurement.

At this step, a post-processing of data, such as moving averages in the time series, can also be performed. For the particular case of the propagation speed and temperature pair, refer to Figure Y as a suggestion to characterize the distinctions.

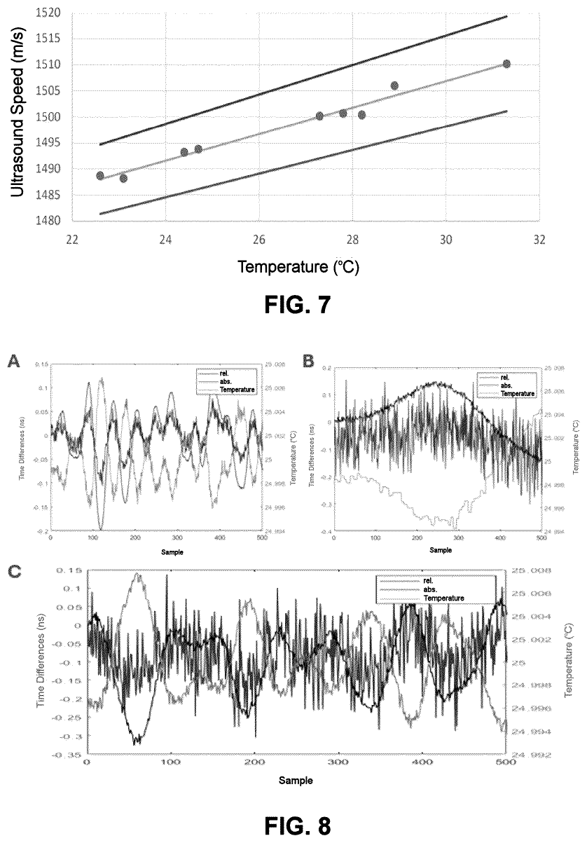

The correlation is then used as the reference equation for corrections in such a sample. In FIG. 7, such an approach is illustrated. Ultrasound propagation speeds measured in water in a measurement system or cell with a 10 mm cuvette are presented as a function of the passive temperature variation. The gray straight line in FIG. 7 represents the linear regression of the data, and the other straight lines are the 95% confidence limits for the linear regression predictions considering Gaussian errors.

For large temperature fluctuations, a trend in their effect is easily noted even in measurement systems with relatively low precision. In FIG. 6, the average standard deviation obtained by ANOVA was 1.18 m/s, but the difference between the measured speeds was close to 25 m/s, mitigating the impact of the high standard deviation on the trend detection.

The large temperature variations, however, are not always of interest, feasible in the measurement system, or linked to equally reliable measurements (related to spurious overlaps or a variation in the effective acoustic path length, for example). In addition, large temperature variations in short times can result in temperature heterogeneities that contribute to increasing the dispersion of the measured data, as in the case of FIG. 6.

Conversely, if the investigation of different temperatures is carried out through different experiments with active temperature control and aiming at achieving steady states, the total investigation time may be too long. In this sense, an alternative approach to developing correlations is obtaining multiple data in the same acoustic experiment with actively controlled temperature. in particular, the acquisition of time series of pulses to be processed and the temperature in the sample.

The main benefits of the strategy are agility, capture of dynamic information that can be analyzed to obtain extra information about the quality of the acquisitions and adequacy of the sampling frequency in the series, as well as the opportunity for post-processing in the series to mitigate the experimental variability of each acquisition, such as through moving averages. However, the strategy is not trivial and demands study of the best approach for data acquisition and processing.

In this sense, the present invention proposed a modification in the paradigm of investigating properties of the samples of interest. Three time series acquisition approaches were tested aiming at monitoring the system under investigation for a total of 3000 points in time.

The methodologies focus on the acquisition of the acoustic pulses of interest for data processing (a1 and a2) and the temperature. The tests are conducted on the apparatus of Tiago et al. (2019) operating without a cuvette and with temperature control in the sample at 25+0.01° C., and water is analyzed as a reference sample and focuses on the sound propagation speed (or, alternatively, time of flight) given the vast literature on the effects of the temperature on the property (DEL GROSSO and MADER, 1972; WILSON, 1959; BILANIUK and WONG, 1993, 1996). Table 2 summarizes the differences between the data acquisition approaches studied, which evaluate:
the number of sequentially obtained pulses that are considered for obtaining average pulses to be stored, a common practice in the state of the art to mitigate the experimental noise in the acoustic acquisition, but which can suppress the dynamics in the signals; in particular, the time instants of the pulses linked to the pulses considered in the average are different from the time instants linked to any “single,” “instantaneous” average or acquisition of temperature. The consideration of 5000 pulses for averages is tested, a value previously considered in experiments conducted in the cell, and 100, a value that is large enough to mitigate jitter problems, but which speeds up the acquisition of the acquisitions by being smaller, and
the explicit waiting or not for a reading update by the equipment responsible for temperature monitoring to start a block of acquisitions, that is, the sequential acquisition of temperature and acoustic signals to represent a time instant in the evolution of the time series. The waiting would contribute to better synchronization between the representation of different variables.

TABLE 2
Characteristics of the investigated
time series acquisition methodologies

| | | Explicitly |
|---|---|---|
| | | waits for |
| | Number of | temperature |
| | acoustic | reading |
| Methodology | averages | update? |
| M1 | 5000 | No |
| M2 | 100 | No |
| M3 | 100 | Yes |

In parallel with the study of acquisition methodologies, the best approach regarding data processing is investigated. In previous studies, there were applied both the relative calculation method (“Rel.” or “Tx”), which considers only different pulses a1 acquired at different time instants or experiments, and the absolute method (“Abs.” or “T/R”), which considers the pulses a1 and a2 acquired at the same time.

However, a systematic comparison between the approaches had not been made, which is now being carried out. Especially for the calculation of the time of flight, used for subsequent calculation of the propagation speed, Tx considers the difference in the detection times of a1 compared to a reference value, while T/R always considers the differences in the detections of a1 and a2.

Table 3 presents statistics regarding the intervals required for the acquisition of each point in the time series when varying the acquisition methodology, as well as the total time for acquiring the complete series. In addition to the summary analysis presented, the detection of an incremental drift in the required intervals in M1 and M2 stands out, which was explained by the absence of pauses in the acquisition, which can lead to the accumulation of background activities on the computer.

The absence of drift and the smaller standard deviation in the intervals highlight M3 as the best approach in terms of isochronicity, typically assumed in data post-processing techniques, such as cross-correlation and autocorrelation.

TABLE 3
Statistics of the intervals required for data acquisition

| | Sampling | Sampling standard | Total acquisition |
|---|---|---|---|
| Methodology | average (s) | deviation (s) | time (min) |
| M1 | 2.6034 | 0.1549 | 130.1250 |
| M2 | 0.3395 | 0.1211 | 16.9714 |
| M3 | 1.6947 | 0.1109 | 84.7079 |

Also from Table 3, it is noteworthy that, despite the greater speed of the acquisitions under M2, the average sampling interval is shorter than the time required to update the readings of the equipment responsible for temperature monitoring, approximately 0.8 s. This implies blocks of “frozen” temperatures acquired, which invalidates the approach. For M2, 81.3% of constant temperatures were observed (resolution of 0.1 mK), that is, identical to the immediately preceding sampling. For M2 and M3, the percentages were 6.7% and 7.1%, considered reasonable given the stochastic steady state.

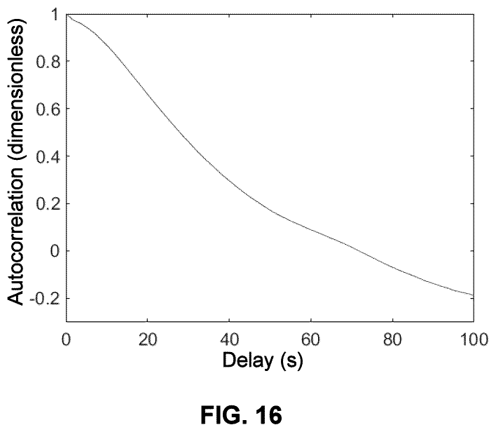

The analysis of the temperature autocorrelation spectrum, see FIG. 16, in a typical result for the used acquisition scheme, indicates a characteristic dynamics time of about 27.9 seconds when considering the methodology described in Schwaab and Pinto (2007). Considering that each individual acoustic acquisition takes on the order of 100 microseconds, even when using averages in the acoustic acquisition, which multiplies the time required for acquisition by the number of samples considered for averaging, the time required is much shorter than the characteristic time of the temperature dynamics.

For example, when considering 100 sequential acquisitions for averaging, the acoustic evaluation would take on the order of 10 milliseconds, that is, almost 3000 times faster, making the hypothesis of constant temperatures throughout the acquisition time reasonable.

FIG. 8 presents an enlargement of the first 500 samples of the time series of temperature and relative (Tx) and absolute (T/R) metrics of the measured time of flight. The metrics of time of flight are shown in terms of differences between the value calculated for a given time instant (sampling) and the value calculated in the first sampling, which implies orders of magnitude analogous to the quantities, allowing comparative views in the same graph.

From FIG. 8, the visual analysis indicates a greater presence of noise in the relative metric (Tx) of time of flight, which can be explained, compared to T/R, by a poorer isolation of the effects in the sample. In Tx, the influence of the temperature on the time spent by the pulses in other components of the measurement system (such as delay lines) are improperly attributed to fluctuations in the sample, generating more noise in the measurements.

However, the acquisition M1 stands out as being less susceptible to such noise comparatively. This can be explained by the larger intervals between samples and the independent temperature control in the measurement system: subsequent samples tend to have more different actual temperatures from each other in M1 and, thus, also more different times of flight; assuming the approximately constant noise magnitude, the M1 signals may appear less noisy due to the lower impact of noise relative to the larger fluctuations in properties, although the accuracy should be analyzed separately.

Finally, in the evaluation of acquisition methodologies and data processing approach philosophy, the capture of the dependence between temperature and time of flight is evaluated. Table 4 presents the Pearson correlations (p) calculated between the time series of temperature and metrics of time of flight. As a reference, for the temperature range between 24.99° C. and 25.01° C., within which the experiments were conducted, there is a correlation of −1 between the time of flight and the temperature considering the reference equation for the speed of sound (BILANIUK and WONG, 1993, 1996) and the assumption of a fixed acoustic path length.

TABLE 4
Correlations between temperature and metric of time of flight

| Methodology | ρ_{T, rel.} | ρ_{T, abs.} |
|---|---|---|
| M1 | −0.8987 | −0.9569 |
| M2 | −0.3977 | −0.9644 |
| M3 | −0.3990 | −0.9662 |

Given the higher correlation modules with the absolute approach, greater similarity of characteristic memory times compared to the temperature and the visual aspect, the absolute calculation approach is recommended. Regarding the data acquisition, M3 is recommended due to its greater speed without data freezing, greater isochronicity, and better synchronization of acquisitions of different variables.

Further, regarding the correlation analysis, it is noteworthy that no processing approach and/or acquisition technique allowed the achievement of the theoretical correlation, which is explained by the remanence of noise and, thus, experimental dispersion. The availability of time series makes it possible to investigate post-processing in the future, such as moving averages in time series; however, it is noteworthy that although the average mitigates noise, it also masks the dynamics, and the ‘trade-off’ between the two effects should be investigated.

With the time series acquisition approach, the possible effect of different positions of the temperature sensor on the sample under analysis was also studied. The multiplicity of experimental points helps in the better understanding the average values of the measured properties and the role of noise in a given experiment.

A total of 3 replicates were performed with the temperature sensor in the reference position, with its active tip in the center of the sample (“run i”), 2 experiments with the sensor in the center of the xy plane of the sample, but above and below the reference position relative to the z-axis (“Ce1” and “Ce2”, respectively) and at analogous heights from the z-axis, but with the sensor close to the corner of the rectangle that is the sample compartment (“Co1” and “Co2”).

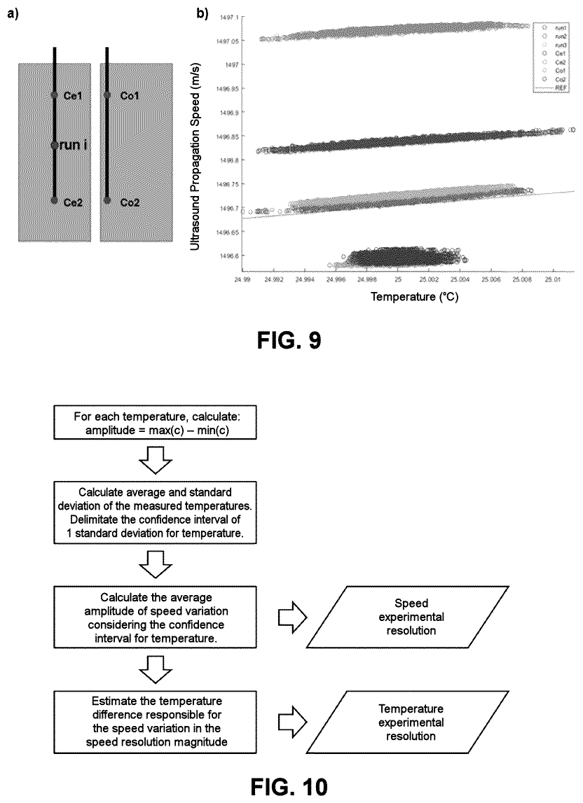

Although the acquisitions “Ce1”, “Ce2”, “Co1” and “Co2” are performed without replicates, the triplicate at the reference point serves as the central point of the study. FIG. 9 schematically presents the investigated positions of the temperature sensor, as well as the measured original experimental clouds. FIG. 9-B also presents expected reference values (“REF”) for the speed.

In FIG. 9-b, the proximity of the experimental clouds for the replicates with the sensor in the reference position (“run1”, “run2” and “run3”) and distance to the alternative positions of the sensor demonstrate the influence of positioning on measurement bias, ratifying the importance of a repetitive experimental positioning for high precision in measured properties.

Finally, Table 5 presents quantitative metrics that summarize the impacts of applying Cross Correlation Spectra, as well as its resilience to the delay present between the evaluated series. For the original series and after displacement, there are calculated the bias, the standard deviation (STD) of the error, the time delay calculated in terms of multiples of the sampling interval (“lag”) and the experimental resolution of sound speed and temperature.

TABLE 5
Statistics of the application of Cross Correlation Spectra

| Metric | R1 | R2 | R3 | Ce1 | Ce2 | Co1 | Co2 |
|---|---|---|---|---|---|---|---|
| Bias: original (cm/s) | 1.18 | 1.14 | 2.22 | 13.39 | 36.87 | −11.59 | −10.91 |
| Bias: without delay (cm/s) | 1.18 | 1.14 | 2.22 | 13.39 | 36.86 | −11.59 | −10.91 |
| SD of error: original (cm/s) | 0.29 | 0.22 | 0.20 | 0.31 | 0.43 | 0.38 | 0.79 |
| SD of error: without delay (cm/s) | 0.24 | 0.14 | 0.15 | 0.28 | 0.41 | 0.33 | 0.70 |
| Resolution in speed: original (cm/s) | 1.28 | 0.91 | 0.83 | 1.02 | 1.21 | 1.51 | 2.91 |
| Resolution in speed: no delay (cm/s) | 1.10 | 0.58 | 0.61 | 0.85 | 1.11 | 1.38 | 2.86 |
| Resolution in temperature: original (mK) | 4.78 | 3.41 | 3.10 | 3.82 | 4.51 | 5.64 | 9.95 |
| Resolution in temperature: no delay (mK) | 4.11 | 2.17 | 2.27 | 3.11 | 4.17 | 5.18 | 9.95 |
| Delay (samples) | −3 | −3 | −4 | −2 | −2 | 12 | 28 |

The strategy adopted for calculating the “effective” experimental resolutions is schematically presented in FIG. 10: initially, the maximum differences between propagation speeds (c) measured for each temperature are computed; the amplitudes related to temperatures in the region of one standard deviation from the measured average temperature are considered in an average to obtain the average amplitude of the speed variation, considering the resolution in terms of temperature.

The strategy of limiting the interval considered important in terms of temperature stands out, given the implemented temperature control; the system temperature tends to be measured close to the average value (control target) and, thus, fewer speed measurements are linked to temperatures far from the average, which impairs its representativeness.

Eventually, only one speed measurement is linked to temperatures far from the average. As for estimating the experimental resolution in terms of temperature, considering the reference equation for the behavior of the propagation speed in the sample, the temperature difference that would be responsible for a speed variation of magnitude equal to the speed resolution is calculated. It is noteworthy that, in the control range of the analyzed experiments, 25±0.01° C., the behavior of the speed with the temperature is linear.

By assuming a constant temperature equal to the target value of the control, the rigid control of 25±0.01° C. allows, for water, fluctuations of up to about 5.35 cm/s in the measured speed which, by not distinguishing between temperatures measured within the control range, make up the experimental variability. By adopting the time series measurement and analysis strategy, the average resolution in propagation speed for the triplicate with the temperature sensor in the reference position was 1.00 cm/s.

### Example of Embodiment A—Application of the Cuvette System in the Analysis of Reference Saline Waters

Experiments were carried out with brines in cuvettes. Concentrations of 0, 35, 55, 140, and 220 ppm of NaCl in distilled water were tested. Average and standard deviation of speeds measured at 25±0.01° C. were obtained, and the concentrations were converted from ppm to molality considering a reference value for density (assuming that the volume measurement took place at 25° C.).

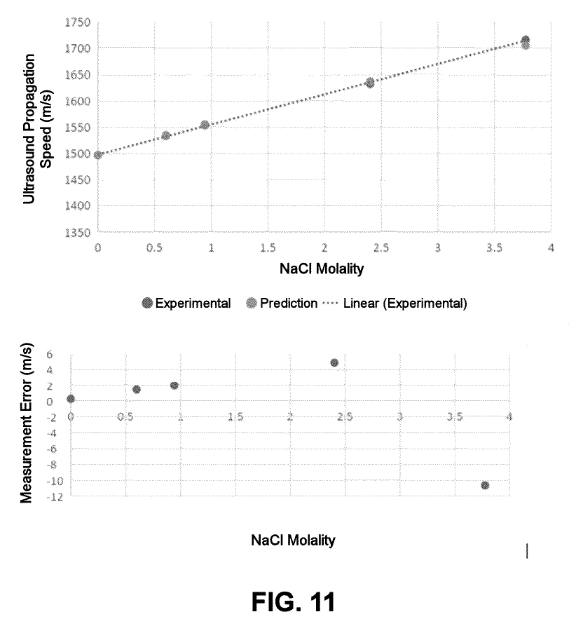

Calculations of the predicted speeds for each concentration (at the temperature and pressure of the experiments) were made using reference equations. MILLERO (1987) presents an equation for the difference between speed in brine and speed in distilled water; this was added to the speed predictions via Bilaniuk and Wong (1993, 1996). The steps that were followed to achieve an application are shown in FIG. 11, and were: Calculation of the error between measurements and theoretical predictions, Fitting of a linear equation to the measurements (averages)—already shown in the graph above—and Evaluation of the error of the fit.

TABLE A1
Characteristics of the analyzed samples

| NaCl | Correlation | Exp | Correlation |
|---|---|---|---|
| Molality | (m/s) | (m/s) | Error (m/s) |
| 0 | 1497.5 | 1496.487 | −1.01328 |
| 0.600707 | 1531.814 | 1532.959 | 1.144667 |
| 0.943968 | 1551.422 | 1553.064 | 1.642499 |
| 2.402828 | 1634.756 | 1631.445 | −3.31058 |
| 3.775872 | 1713.188 | 1714.68 | 1.492392 |

The high accuracy in the molality values and the very low error level in the speed data lead to the assertion that the System for measuring the salinity of various brines can be used.

### Example of Embodiment B-Application of the Cuvette System in the Analysis of Reference Oily Waters

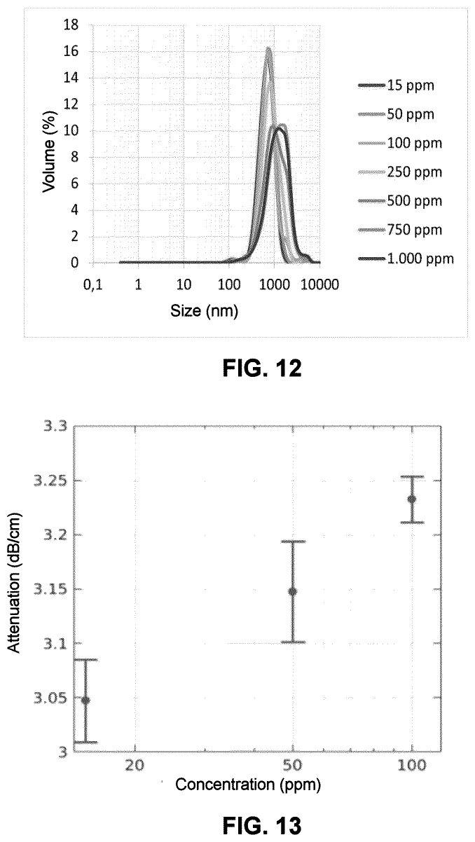

The cuvette system was used in the investigation of reference oily waters with known and approximately constant dispersed droplet size between different concentrations of EMCA mineral oil dispersed in distilled water, see FIG. 12. Initially, concentrations from 0 to 1000 ppm were studied.

The initial analysis of emulsions was performed with assembly, operation and data processing analogous to that reported in Tiago et al. (2019), that is, a quartz cuvette with a nominal path length of 10 mm was applied, experimental points were acquired (5 sequential acquisitions, but only the first one was considered) in the experiments and a relative data processing was applied comparing the signal a1 in the sample of interest with the signal a1 in a calibration sample, distilled water.

Average values were considered representative of the experiments considering frequencies in which there is an overlap of the −6 dB bands in the frequency responses of the pulses a1 considered in the relative processing.

FIG. 13 explores the attenuation coefficient of the samples measured at 40 MHz, a frequency close to the peak frequency in the pulses, as a possible way to distinguish between the samples; 9 experiments per concentration are considered in the calculations of average and confidence interval (presented as bars). The response indicates the possibility of using the technique with restriction of the variability in the range of interest, up to 100 ppm.

The data were generated from various triplicate experiments. After each set of triplicates, the data were processed and, if there was a significant difference between the measured properties (speed and/or attenuation coefficient) for at least 1 of the experiments, extra experiments were performed until there was a subset with 3 close measurements. The proximity criteria were established in light of the results that validated the measurement system reported in Tiago et al. (2019).

The scenario was analogous in the investigation of different oil concentrations in saline oily waters with 35000, 55000, 140000, and 220000 ppm of NaCl. Table B1 highlights the reduction in the variability when correcting the measured properties for a reference temperature; thus, considering the temperature measurement with a resolution of 0.1 mK and the control of ±0.01° C., a similar study applies.

However, instead of considering the constant acoustic path length and using the different measured speeds to analyze the impacts of the temperature, as in Table B1, it was decided to use the temperature to correct the acoustic path length experienced by ultrasound.

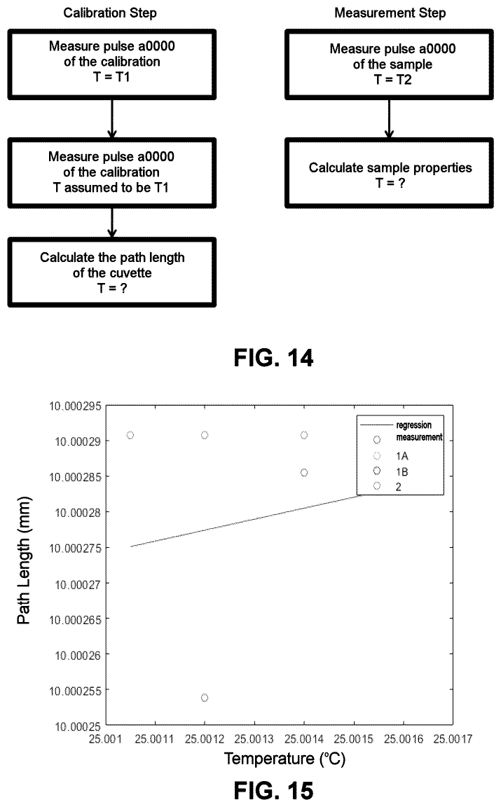

However, a complication in temperature corrections is the way in which the data were acquired in the batches of emulsion tests carried out so far, summarized in FIG. 14. It should be highlighted that the temperature measured at the time of acquisition of the pulses a1 considered in the processing may be different. In addition, there may be a difference between the temperatures of the pulses a1 and a2 in the calibration file (considered in the acoustic path length measurement), introducing extra variability when varying calibration files between measurements.

With the available data, assuming the temperature constancy between the signals a1 and a2 in each of the 5 sequential acquisitions in the considered calibration file, regression lines were determined for the acoustic path length as a function of temperature. Considering the fixed distance between the delay lines present in the measurement system, but variable thicknesses to the other elements, the calculated times of flight are corrected for the temperature of 25.0000° C. Corrections are explored only in the propagation speed at first.

Table B1 quantifies the average and standard deviation of the speeds considered without and with temperature corrections. There was no significant alteration in the data dispersion, which was explained by the inability of the acquisition combined with the data processing, as done until then, to detect the impacts of the small temperature fluctuations on the acoustic signals.

This fact is demonstrated in FIG. 15, which shows the variations in acoustic path length as a function of the temperature measured for DGA2 calibration; the observed fluctuations are much larger than the predictions of different theoretical models (named 1A, 1B and 2); thus, the fluctuations are marked by noise.

TABLE B1
Impact of temperature corrections in the second batch of tests

| | | | | Average phase | | |
|---|---|---|---|---|---|---|
| | | Average phase | | speed in | SD of | |
| | | speed in | SD of | the −6 | Average | |
| EMCA | Salinity | the −6 | Average phase | dB band | phase speed | Num. |
| (ppm) | (k ppm) | dB band | speed | CORRECTED | CORRECTED | files |
| 0 | 35 | 1532.371 | 0.135 | 1532.377 | 0.132 | 3 |
| 15 | 35 | 1533.275 | 0.045 | 1533.275 | 0.043 | 3 |
| 100 | 35 | 1533.762 | 0.171 | 1533.759 | 0.170 | 3 |
| 0 | 55 | 1552.463 | 0.402 | 1552.448 | 0.397 | 3 |
| 15 | 55 | 1554.016 | 0.146 | 1554.013 | 0.141 | 3 |
| 100 | 55 | 1554.151 | 0.257 | 1554.135 | 0.261 | 3 |
| 0 | 140 | 1630.780 | 0.062 | 1630.768 | 0.070 | 3 |
| 15 | 140 | 1640.060 | 0.143 | 1640.061 | 0.157 | 3 |
| 100 | 140 | 1641.131 | 0.802 | 1641.114 | 0.820 | 3 |
| 0 | 220 | 1713.947 | 1.061 | 1713.921 | 1.040 | 3 |
| 15 | 220 | 1714.702 | 0.264 | 1714.692 | 0.271 | 3 |
| 100 | 220 | 1714.518 | 0.327 | 1714.521 | 0.332 | 3 |

Key: 1- Phase speed: phase speed of ultrasound propagation; 2- SD: standard deviation; and 3 - Num. files: number of files/measurements available.

The conclusion from the data in Table B1 is that there is an increase in the apparent average speed as a function of the presence of oil that can be used for OGC measurement, especially in low salinity.

Those skilled in the art will appreciate the knowledge presented herein and may reproduce the invention in the presented embodiments and in other variants, encompassed within the scope of the attached claims.

### REFERENCES

ADAMOWSKI, Julio C. et al. Ultrasonic measurement of density of liquids. The Journal of the Acoustical Society of America, v. 97, n. 1, p. 354-361, 1995. DOI: 10.1121/1.412320.
ADAMOWSKI, Julio C. et al. Ultrasonic measurement of micrometric wall-thickness loss due to corrosion inside pipes. In: 2013 IEEE International Ultrasonics Symposium (IUS). IEEE, 2013. p. 1881-1884.
ADAMOWSKI, Julio Cezar et al. Sensores: Teoria e Aplicações. Laboratório de Sensores e Atuadores. Departamento de Engenharia e de Sistemas Mecânicos. Escola Politécnica da USP. 2000.
BILANIUK, Nykolai; WONG, George SK. Erratum: Speed of sound in pure water as a function of temperature [J. Acoust. Soc. Am. 93, 1609-1612 (1993)]. The Journal of the Acoustical Society of America, v. 99, n. 5, p. 3257-3257, 1996.
BILANIUK, Nykolai; WONG, George SK. Speed of sound in pure water as a function of temperature. The Journal of the Acoustical Society of America, v. 93, n. 3, p. 1609-1612, 1993.
BONACUCINA, Giulia et al. Acoustic spectroscopy: a powerful analytical method for the pharmaceutical field?. International Journal of Pharmaceutics, v. 503, n. 1-2, p. 174-195, 2016. DOI: 10.1016/j.ijpharm.2016.03.009.
CARVALHO, Rogério Mesquita de; “Avaliação da Utilização da Espectroscopia Acústica na Análise de Sistemas Multifásicos de Petróleo”. 2013. Doctoral Thesis, UFRJ.
DEL GROSSO, V. A.; MADER, C. W. Speed of sound in pure water. The Journal of the Acoustical Society of America, v. 52, n. 5B, p. 1442-1446, 1972.
DEMING, S. N. et al. Correlation Methods. In: Deming, S. N. et al. (Eds.). Chemometrics: A Textbook, 1st ed. Elsevier Science, vol. 2, p. 191-213, 1988.
KOCHER, Johannes; HANSSON, Lars. Disposição de sustentação para um transmissor acústico em um sistema de espectroscopia acústica. Applicant: ACOSENSE AB. BR 112019026994-0 A2. Filing date: 19 Jun. 2018.
LUBBERS, J.; GRAAFF, R. A simple and accurate formula for the sound velocity in water. Ultrasound in medicine & biology, v. 24, n. 7, p. 1065-1068, 1998. DOI: 10.1016/s0301-5629(98)00091-x.
MATHWORKS. Cross-correlation—MATLAB xcorr. Available at: <https://www.mathworks.com/help/matlab/ref/xcorr.html>. Accessed on: Feb. 7, 2024. Norisuye, T. et al. “Simultaneous evaluation of ultrasound velocity, attenuation and density of polymer solutions observed by multi-echo ultrasound spectroscopy.” Ultrasonics, vol. 51, pp. 215-222, February 2011. Available at: https://linkinghub.elsevier.com/retrieve/pii/S0041624X10001198.
NUMPY. numpy.correlate-NumPy v1.26 Manual. Available at: <https://numpy.org/doc/stable/reference/generated/numpy.correlate.html>. Accessed on: Feb. 7, 2024.
Schwaab, M.; Pinto, J. C. Análise de Dados Experimentais I. e-papers, 2007, vol. 1.
SCIPY. scipy.signal.correlate-SciPy v1.12.0 Manual. Available at: <https://docs.scipy.org/doc/scipy/reference/generated/scipy.signal.correlate.html>. Accessed on: Feb. 7, 2024.
SILVA, Luciano Segné F. et al. Desenvolvimento de uma técnica ultrassônica para avaliar teores de óleo e graxa em efluentes de biocombustíveis. Química Nova, v. 38, p. 1339-1344, 2015.
STATSMODELS. statsmodels.tsa.stattools.ccf-statsmodels 0.14.1. Available at: <https://www.statsmodels.org/stable/generated/statsmodels.tsa.stattools.ccf.html>. Accessed on: Feb. 7, 2024.
TIAGO, Marcelo Moreira et al.; Versatile ultrasonic spectrometer for liquids with practical sample handling by using standard cuvettes. IEEE Transactions on Ultrasonics, Ferroelectrics, and Frequency Control, v. 66, n. 1, p. 109-118, 2018.
Wilson, W. D.; “Speed of sound in distilled water as a function of temperature and pressure.” The Journal of the Acoustical Society of America, vol. 31, no. 8, pp. 1067-1072, 1959.
SCHWAAB, M.; PINTO, J. C. Análise de Dados Experimentais I. Rio de Janeiro: e-papers, 2007. v. 1.

1. A system for acoustic spectroscopy for fluid measurement, wherein the system characterized in that it is manufactured by 3D printing and comprises:
a central hole for direct insertion of the fluid to be analyzed, or
a cuvette with liquid for acoustic coupling,
two secondary side holes located on the sides of the central hole,
a sealing ring,
an acoustic transducer,
two support arms,
wherein the ends of each support arm comprise elliptical structures with holes,
wherein the elliptical structures with holes allow the insertion of nuts and bolts.

2. The system of claim 1, wherein the acoustic transducer is fitted into each secondary side hole.

3. The system of claim 1, wherein the spectroscopy is pulsed transmission-reception or pulse-echo.

4. The system of claim 1, wherein the fluids are multiphase, wherein the fluids comprise oil-in-water or water-in-oil emulsions in the presence of solids.

5. The system of claim 1, wherein the nuts and bolts are used to move the transducers.

6. The system of claim 1, wherein the cuvettes comprise nominal path lengths of 10 mm, 20 mm or 30 mm.

7. The system of claim 1, further comprising a temperature control mechanism.

8. The system of claim 1, wherein the acoustic transducer is a delay line transducer.

9. A method for acoustic spectroscopy for fluid measurement, comprising:
1) constructing the system of claim 1, which allows a measurement resolution of the variables of interest greater than the limits of the imposed active control;
2) executing an active control of the variables of interest and waiting until a steady state is reached;
3) monitoring the variables of interest for a sufficiently long time to allow multiple evaluations of the same state of the dependent variable in the range of interest; and
4) analyzing all measurements in the time series jointly, in order to characterize and mitigate the impacts of the individual noise from each measurement.

10. The method of claim 9, wherein the variables of interest are: sound propagation speed and temperature.
